(19) United States
(12) Patent Application Publication
(10) Pub. No.: US 2025/0106750 A1
(43) Pub. Date: Mar. 27, 2025

(54) METHOD AND APPARATUS FOR NON-3GPP ACCESS NODE SELECTION

(71) Applicant: LENOVO (SINGAPORE) PTE. LTD, Singapore (SG)

(72) Inventor: Apostolis SALKINTZIS, Athens (GR)

(21) Appl. No.: 18/730,554

(22) PCT Filed: Mar. 3, 2022
(86) PCT No.: PCT/EP2022/055493

§ 371 Date: Jul. 19, 2024

(30) Foreign Application Priority Data
Jan. 21, 2022 (GR) 20220100059

(51) Int. Cl. H04W 48/18; H04L 61/4511; H04L 65/1016; H04W 84/04

(52) U.S. Cl. CPC H04W 48/18; H04L 61/4511; H04L 65/1016; H04W 84/042

(57) ABSTRACT

There is provided a user apparatus comprising a transceiver arranged to communicate with a non-3GPP access network; and a processor arranged to: determine that a non-3GPP access node is to be selected for providing a first service over the non-3GPP access network; send a first DNS request, via the transceiver, the first DNS request using a first visited country FQDN associated with a first type of non-3GPP access node; receive a first DNS response, via the transceiver, the first DNS response containing a first list of PLMN identities; send a second DNS request, via the transceiver, the second DNS request using a second visited country FQDN associated with a second type of non-3GPP access node; receive a second DNS response, via the transceiver, the second DNS response containing a second list of PLMN identities; select a non-3GPP access node based upon the received first and second DNS responses.

### FIELD

The subject matter disclosed herein relates generally to the field of implementing non-3GPP access node selection. This document defines a user apparatus, a method in a user apparatus arranged to communicate with a non-3GPP access network, a non-3GPP access point, and a method performed by a non-3GPP access point.

### BACKGROUND

3GPP Technical Specification 23.501 v17.3.0 defines the “Combined N3IWF/ePDG selection” procedure at section 6.3.6.3. When the UE determines it is to provide a service (e.g., an IMS service) over untrusted non-3GPP access and the UE is not already connected to a public land mobile network (PLMN) via untrusted non-3GPP access, the UE may connect to a non-3GPP access network (e.g., to a public or residential WLAN). What the UE does next depends on whether the UE supports connectivity with ePDG only, connectivity with N3IWF only, or connectivity with both ePDG and N3IWF. The “Combined N3IWF/ePDG selection” is also referred to as “Non-3GPP access node selection” because the N3IWF and the ePDG are different types of non-3GPP access nodes.

IMS (IP-Multimedia Subsystem) was originally designed to evolve UMTS networks to deliver Internet Protocol multimedia to mobile users. IMS has since become a core component within 3G, cable TV and next generation fixed telecoms networks. IMS specification began in 3GPP Release 5 as part of the core network evolution from circuit-switching to packet-switching and was refined by subsequent Releases 6 and 7. Initially, IMS was an all-IP system designed to assist mobile operators deliver next generation interactive and interoperable services, cost-effectively, over an architecture providing the flexibility of the Internet. The Session Initiation Protocol (SIP) is the signaling mechanism for IMS, thereby allowing voice, text and multimedia services to traverse connected networks.

### SUMMARY

A problem with the “Combined N3IWF/ePDG selection” procedure defined at section 6.3.6.3 3GPP Technical Specification 23.501 v17.3.0 is that the DNS operation is unclear when both N3IWF and ePDG are available to a mobile device. Further, the currently defined procedure does not specify to which FQDN the DNS request should be sent.

Disclosed herein are procedures for non-3GPP access node selection. Said procedures may be implemented by a user apparatus, a method in a user apparatus arranged to communicate with a non-3GPP access network, a non-3GPP access point, and a method performed by a non-3GPP access point.

There is provided a user apparatus comprising a transceiver arranged to communicate with a non-3GPP access network, and a processor. The processor is arranged to determine that a non-3GPP access node is to be selected for providing a first service over the non-3GPP access network, and send a first DNS request, via the transceiver, the first DNS request using a first visited country FQDN associated with a first type of non-3GPP access node. The processor is further arranged to receive a first DNS response, via the transceiver, the first DNS response containing a first list plurality of PLMN identities, and send a second DNS request, via the transceiver, the second DNS request using a second visited country FQDN associated with a second type of non-3GPP access node. The processor is further arranged to receive a second DNS response, via the transceiver, the second DNS response containing a second list plurality of PLMN identities, and select a non-3GPP access node based upon the received first and second DNS responses.

There is further provided a method in a user apparatus arranged to communicate with a non-3GPP access network, the method comprising determining that a non-3GPP access node is to be selected for providing a first service over the non-3GPP access network. The method further comprises sending a first DNS request, via the transceiver, the first DNS request using a first visited country FQDN associated with a first type of non-3GPP access node, and receiving a first DNS response, via the transceiver, the first DNS response containing a first list of PLMN identities. The method further comprises sending a second DNS request, via the transceiver, the second DNS request using a second visited country FQDN associated with a second type of non-3GPP access node; and receiving a second DNS response, via the transceiver, the second DNS response containing a second list of PLMN identities. The method further comprises selecting a non-3GPP access node based upon the received first and second DNS responses.

There is further provided a non-3GPP access point comprising a transceiver arranged to communicate with a user apparatus via a non-3GPP access network; and a processor. The processor is arranged to receive a first DNS request, via the transceiver, the first DNS request using a first visited country FQDN associated with a first type of non-3GPP access node, and send a first DNS response, via the transceiver, the first DNS response containing a first list of PLMN identities. The processor is further arranged to receive a second DNS request, via the transceiver, the second DNS request using a second visited country FQDN associated with a second type of non-3GPP access node; and send a second DNS response, via the transceiver, the second DNS response containing a second list of PLMN identities.

There is further provided a method performed by a non-3GPP access point arranged to communicate with a user apparatus via a non-3GPP access network. The method comprises receiving a first DNS request, via the transceiver, the first DNS request using a first visited country FQDN associated with a first type of non-3GPP access node; and sending a first DNS response, via the transceiver, the first DNS response containing a first list of PLMN identities. The methos further comprises receiving a second DNS request, via the transceiver, the second DNS request using a second visited country FQDN associated with a second type of non-3GPP access node, and sending a second DNS response, via the transceiver, the second DNS response containing a second list of PLMN identities.

### BRIEF DESCRIPTION OF THE DRAWINGS

In order to describe the manner in which advantages and features of this disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for non-3GPP access node selection will now be described, byway of example only, with reference to the accompanying drawings, in which:

FIG. 1 illustrates a system for non-3GPP access to a 3GPP core network;

FIG. 2 depicts a user equipment apparatus that may be used for implementing the methods described herein;

FIG. 3 depicts further details of the network node that may be used for implementing the methods described herein;

FIG. 4 illustrates a method in a user apparatus arranged to communicate with a non-3GPP access network;

FIG. 5 illustrates a method performed by a non-3GPP access point arranged to communicate with a user apparatus via a non-3GPP access network;

FIG. 6 illustrates a typical system for implementing the methods and apparatus described herein;

FIG. 7 illustrates a method of a UE communicating with a DNS server and performing non-3GPP access selection for an IMS service; and

FIG. 8 illustrates a method of a UE communicating with a DNS 830 and performing non-3GPP access selection for a non-IMS service.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain arrangement, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding figures. Like numbers refer to like elements in all figures.

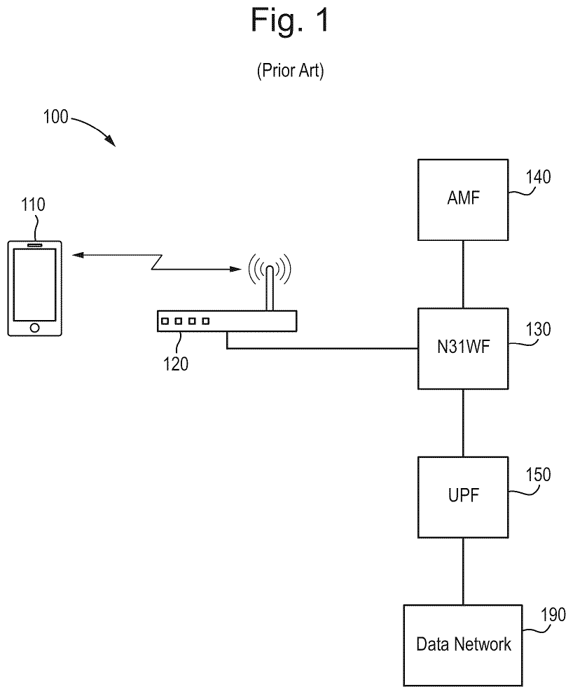

FIG. 1 illustrates a system 100 for non-3GPP access to a 3GPP core network. The system comprises a user equipment 110, a WiFi™ access point 120, a Non-3GPP Inter Working Function (N3IWF) 130, an Access Management Function (AMF) 140, a User Plane Function (UPF) 150 and a data network 190. The data network 190 might be the internet. The N3IWF 130 facilitates a connection between the non-3GPP network, in this case a WiFi™ Network, and the 3GPP network, in this case a 5G network comprising AMF 140 and UPF 150. UE 110 establishes a data connection with WiFi™ access point 120 according to, for example, the IEEE 802.11n standard. WiFi™ access point 120 is connected to the 3GPP network via N3IWF 130 which facilitates a data connection over the UPF 150 to a data network 190.

Similar functionality to that of a N3IWF 130 in a 5G 3GPP network is provided in a 4G 3GPP network by an Evolved Packet Data Gateway (ePDG).

A UE may determine that it will provide a service, such as an IMS service, over an untrusted non-3GPP access. If the UE is not already connected to a PLMN via untrusted non-3GPP access when the determination to provide the service is made, then the UE connects to a non-3GPP access network, such as a public or residential WLAN, and then performs the following operations:
(a) If the UE supports only connectivity with ePDG, the UE performs “ePDG selection” (as defined in TS 23.402 v17.0.0, clause 4.5.4) in order to select and connect to an ePDG in a PLMN; or
(b) If the UE supports only connectivity with N3IWF, the UE performs “N3IWF selection” (as defined in TS 23.501 v17.3.0, clause 6.3.6.2), in order to select and connect to an N3IWF in a PLMN; or
(c) If the UE supports both connectivity with ePDG and connectivity with N3IWF, the UE performs “Combined N3IWF/ePDG selection” (as defined in TS 23.501 v17.3.0, clause 6.3.6.3) in order to select and connect to either an N3IWF or an ePDG in a PLMN.

The “Combined N3IWF/ePDG selection” is also referred to as “Non-3GPP access node selection” because the N3IWF and the ePDG are different types of non-3GPP access nodes.

When the UE performs “ePDG selection” and the UE is located in a visited country (i.e., in a country other than its home country), the UE may need to discover whether the visited country mandates the selection of ePDG in this visited country. For this purpose, the UE sends a DNS request with Fully Qualified Domain Name (FQDN)=“epdg.epc.mcc<MCC>.visited-country.pub.3gppnetwork.org”, where <MCC> is the Mobile Country Code of the visited country. If the DNS response contains no records, then the UE determines that the visited country does not mandate the selection of ePDG in this country. If the DNS response contains one or more records, then the UE determines that the visited country mandates the selection of ePDG in this country, and each record contains the identity of a PLMN in the visited country that may be used for ePDG selection.

When the UE performs “N3IWF selection” and the UE is located in a visited country, the UE may need to discover whether the visited country mandates the selection of N3IWF in this visited country. For this purpose, the UE sends a DNS request with FQDN=“n3iwf.5gc.mcc<MCC>.visited-country.pub.3gppnetwork.org”, where <MCC> is the Mobile Country Code of the visited country. If the DNS response contains no records, then the UE determines that the visited country does not mandate the selection of N3IWF in this country. If the DNS response contains one or more records, then the UE determines that the visited country mandates the selection of N3IWF in this country, and each record contains the identity of a PLMN in the visited country that may be used for N3IWF selection.

When the UE performs “Combined N3IWF/ePDG selection” and the UE is located in a visited country, the UE may need to discover whether the visited country mandates the selection of N3IWF or ePDG in this country. The present “Combined N3IWF/ePDG selection” procedure in TS 23.501 v17.3.0, clause 6.3.6.3 merely states that the UE sends a single DNS request and does not make clear which FQDN is used.

There is presented herein a solution to this problem, wherein for proper functionality the UE sends two DNS requests: one in relation to N3IWF, and the other in relation to ePDG. The first DNS request may have FQDN=“n3iwf.5gc.mcc<MCC>.visited-country.pub.3gppnetwork.org” and the second DNS request may have FQDN=“epdg.epc.mcc<MCC>.visited-country.pub.3gppnetwork.org”. The UE may then consolidate the identities of the PLMNs it receives in the two DNS responses, select one of these PLMNs and then select an access node in the selected PLMN. Such an arrangement allows a UE to properly perform a combined N3IWF/ePDG selection. Such an arrangement is not specified in the present “Combined N3IWF/ePDG selection” procedure of TS 23.501 v17.3.0, clause 6.3.6.3.

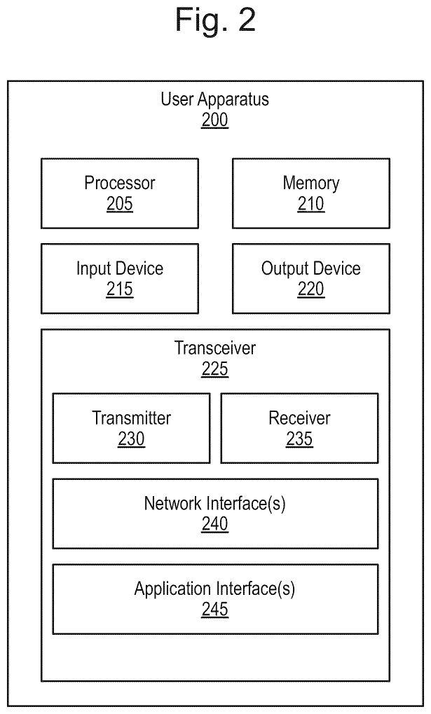

FIG. 2 depicts a user equipment apparatus 200 that may be used for implementing the methods described herein. The user equipment apparatus 200 is used to implement one or more of the solutions described herein, and may comprise a UE 110, 610, 710 and/or 810 as described herein. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the above-described UE behaviors. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as describe above. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide UL communication signals to a base unit of a wireless communications network. Similarly, the one or more receivers 235 may be used to receive DL communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

The user apparatus 200 of FIG. 2, comprises the transceiver 225 arranged to communicate with a non-3GPP access network and the processor 205. The processor 205 may be arranged to determine that a non-3GPP access node is to be selected for providing a first service over the non-3GPP access network. The processor 205 may be further arranged to send a first DNS request, via the transceiver, the first DNS request using a first visited country FQDN associated with a first type of non-3GPP access node. The processor 205 may be further arranged to receive a first DNS response, via the transceiver, the first DNS response containing a first list of PLMN identities. The processor 205 may be further arranged to send a second DNS request, via the transceiver, the second DNS request using a second visited country FQDN associated with a second type of non-3GPP access node. The processor 205 may be further arranged to receive a second DNS response, via the transceiver, the second DNS response containing a second list of PLMN identities. The processor 205 may be further arranged to select a non-3GPP access node based upon the received first and second DNS responses.

The user apparatus may be a user equipment (UE). The non-3GPP access node may be an ePDG or an N3IWF. The first service may be an IMS service. The user apparatus may be a roaming user apparatus. The roaming user apparatus may be defined as roaming by virtue of it being unable to connect to its home network. Roaming extends the coverage of a home operator's network services by allowing a user equipment to use another operator's network, which may be in another country (international roaming) or in the same country (national roaming).

The user apparatus may be determined that a non-3GPP access node is to be selected for providing a first service over the non-3GPP access network in response to determining that an IMS service should be provided over non-3GPP access and the user apparatus is located in a visited country and it is not already connected to a non-3GPP access node. In such a situation the user apparatus must select and connect to a non-3GPP access node for being able to provide the IMS service.

The selected non-3GPP access node can be located in a visited PLMN, or in the home PLMN. How a PLMN is selected is specified in 3GPP specs (such as TS 23.501 v17.0.0 and TS 24.502 v17.4.0). For example, the selected PLMN may be the highest priority PLMN in the N3ANSI. The N3ANSI is non-3GPP access network selection information which is received by the UE. The HPLMN sends the N3ANSI to the UE. The N3ANSI comprises a prioritized list of PLMNs. For each PLMN the N3ANSI includes (i) a “Preference” parameter which indicates if ePDG or N3IWF is preferred in this PLMN and (ii) an FQDN parameter which indicates if the Tracking/Location Area Identity FQDN or the Operator Identifier FQDN (as specified in clause 4.5.4.4 of TS 23.402 v17.0.0) should be used when discovering the address of an ePDG or N3IWF in this PLMN. The list of PLMNs includes the HPLMN and an “any PLMN” entry, which matches any PLMN the UE is connected to except the HPLMN.

The ePDG identifier configuration and the N3IWF identifier configuration are optional parameters. The Non-3GPP access node selection information includes at least the HPLMN and the “any PLMN” entry. If the ePDG identifier configuration is configured in the UE, then, when the UE decides to select an ePDG in the HPLMN (according to the procedure in clause 6.3.6.3 of TS 23.402 v17.0.0), the UE uses the ePDG identifier configuration to find the IP address of the ePDG in the HPLMN and ignores the FQDN parameter of the HPLMN in the Non-3GPP access node selection information. If the N3IWF identifier configuration is configured in the UE, then, when the UE decides to select an N3IWF in the HPLMN (according to the procedure in clause 6.3.6.3 of TS 23.402 v17.0.0 for combined N3IWF/ePDG selection and the procedure in clause 6.3.6.2 of TS 23.402 v17.0.0 for Stand-alone N3IWF selection), the UE uses the N3IWF identifier configuration to find the IP address of the N3IWF in the HPLMN and ignores the FQDN parameter of the HPLMN in the Non-3GPP access node selection information. The HPLMN provides to the UE the Non-3GPP access node selection information and the N3IWF identifier configuration by taking into account the UE's subscribed S-NSSAIs for non-3GPP access.

How a first type or a second type of non-3GPP access node in the selected PLMN is selected, is specified already in 3GPP specs (TS 23.501 v17.0.0 and TS 24.502 v17.4.0). For example, the “preference” parameter in the N3ANSI may be used for selecting the PLMN. If the “preference” indicates N3IWF but the UE cannot connect to an N3IWF in the selected PLMN, then the UE attempts to connect to an ePDG in the selected PLMN. If the “preference” indicates ePDG but the UE cannot connect to an ePDG in the selected PLMN, then the UE attempts to connect to an N3IWF in the selected PLMN. If that fails too, the UE goes back and selects another PLMN from the candidate list of PLMNs (e.g., the second highest priority PLMN in the N3ANSI).

The user apparatus sends two DNS requests and constructs a candidate list of PLMNs from the received two DNS responses. It then selects a PLMN from the candidate list of PLMNs. Either or both DNS response may comprise a list with zero entries.

The processor 205 may be further arranged to: construct a candidate list of PLMNs using the first list of PLMN identities and the second list of PLMN identities; and select a PLMN from the candidate list of PLMNs; wherein selecting a non-3GPP access node based upon the received first and second DNS responses comprises selecting a first type or a second type of non-3GPP access node in the selected PLMN.

The candidate list of PLMNs may contain the PLMNs in the visited country which can be used for selecting the first type of non-3GPP access node and may contain the PLMNs in the visited country which can be used for selecting the second type of non-3GPP access node.

The first type of non-3GPP access node may be a N3IWF. The First visited country FQDN may comprise “n3iwf.5gc.mcc<MCC>.visited-country.pub.3gppnetwork.org”, where MCC is the Mobile Country Code of the visited country.

The first DNS response contains the PLMN identities in the visited country that can be used for N3IWF selection. The first DNS response may indicate that no PLMNs in the visited country can be used for N3IWF selection. The first DNS response may indicate that no PLMNs in the visited country can be used for N3IWF selection by comprising a list of PLMN identities having zero entries.

The second type of non-3GPP access node may be an ePDG. The second visited country FQDN may comprise “epdg.epc.mcc<MCC>.visited-country.pub.3gppnetwork.org”, where MCC is the Mobile Country Code of the visited country. Typically, the second DNS request may be sent only in response to determining that the first service is an IMS service.

The second DNS response may contain the PLMN identities in the visited country which can be used for ePDG selection. The second DNS response may indicate that no PLMNs in the visited country can be used for ePDG selection. The second DNS response may indicate that no PLMNs in the visited country can be used for ePDG selection by comprising a list of PLMN identities having zero entries.

The first service may be an IMS service, and the user apparatus may send the first DNS request and the second DNS request in response to determining that the non-3GPP access node selection is required for providing an IMS service. The user apparatus may send only the first DNS request in response to determining that the non-3GPP access node selection is required for providing a non-IMS service.

When the non-3GPP access node selection is required for providing a non-IMS service, the user apparatus may send the first DNS request, but may not send the second DNS request. The second DNS request may be sent only when the non-3GPP access node selection is required for providing an IMS service.

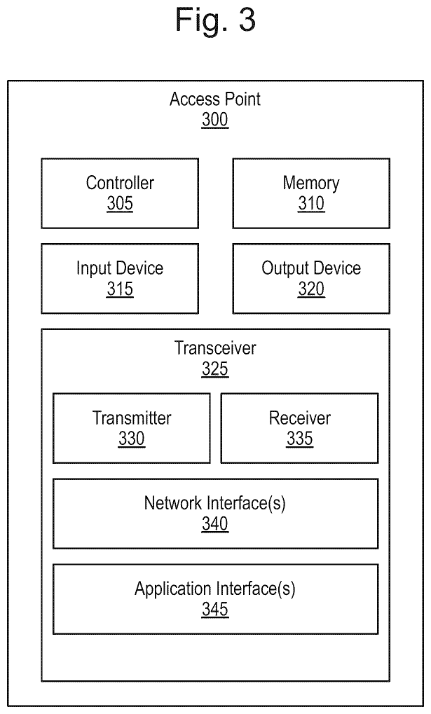

FIG. 3 depicts further details of the network node 300 that may be used for implementing the methods described herein. The network node 300 may be an access point in a non-3GPP network, for example access point 120 or 620 as described herein. The network node 300 includes a controller 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the controller 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The controller 305 may include any known controller capable of executing computer-readable instructions and/or capable of performing logical operations. For example, the controller 305 may be a microcontroller, a microprocessor, a CPU, a GPU, an auxiliary processing unit, a FPGA, or similar programmable controller. The controller 305 may execute instructions stored in the memory 310 to perform the methods and routines described herein. The controller 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described above. The memory 310 may also stores program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

The non-3GPP access point 300 of FIG. 3, may comprise the transceiver 325 arranged to communicate with a user apparatus via a non-3GPP access network, and the controller 305 in the form of a processor. The processor may be arranged to receive a first DNS request, via the transceiver, the first DNS request using a first visited country FQDN associated with a first type of non-3GPP access node. The processor may be arranged to send a first DNS response, via the transceiver, the first DNS response containing a first list of PLMN identities. The processor may be arranged to receive a second DNS request, via the transceiver, the second DNS request using a second visited country FQDN associated with a second type of non-3GPP access node. The processor may be arranged to send a second DNS response, via the transceiver, the second DNS response containing a second list of PLMN identities.

The non-3GPP access point may be a WLAN access point such as a WiFi™ access point. The user apparatus may be a user equipment (UE). The non-3GPP access node may be an ePDG or an N3IWF. The first service may be an IMS service.

The processor may be further arranged to receive from the user apparatus, via the transceiver, an indication of a selection of a non-3GPP access node based upon the first and second DNS responses sent to the user apparatus.

The user apparatus may determine that a non-3GPP access node is to be selected for providing a first service over the non-3GPP access network in response to determining that an IMS service should be provided over non-3GPP access and the user apparatus is located in a visited country and it is not already connected to a non-3GPP access node. In such a situation the user apparatus may select and connect to a non-3GPP access node for being able to provide the IMS service.

The selected non-3GPP access node can be located in a visited PLMN, or in the home PLMN. How a PLMN is selected is specified in 3GPP specs (such as TS 23.501 v17.0.0 and TS 24.502 v17.4.0). For example, the selected PLMN may be the highest priority PLMN in the N3ANSI.

How a first type or a second type of non-3GPP access node in the selected PLMN is selected, is specified already in 3GPP specs (TS 23.501 v17.0.0 and TS 24.502 v17.4.0). For example, the “preference” parameter in the N3ANSI may be used for selecting the PLMN. If the “preference” indicates N3IWF but the UE cannot connect to an N3IWF in the selected PLMN, then the UE attempts to connect to an ePDG in the selected PLMN. If the “preference” indicates ePDG but the UE cannot connect to an ePDG in the selected PLMN, then the UE attempts to connect to an N3IWF in the selected PLMN. If that fails too, the UE goes back and selects another PLMN from the candidate list of PLMNs (e.g., the second highest priority PLMN in the N3ANSI).

The user apparatus may thus send two DNS requests and constructs a candidate list of PLMNs from the received two DNS responses. It may then select a PLMN from the candidate list of PLMNs.

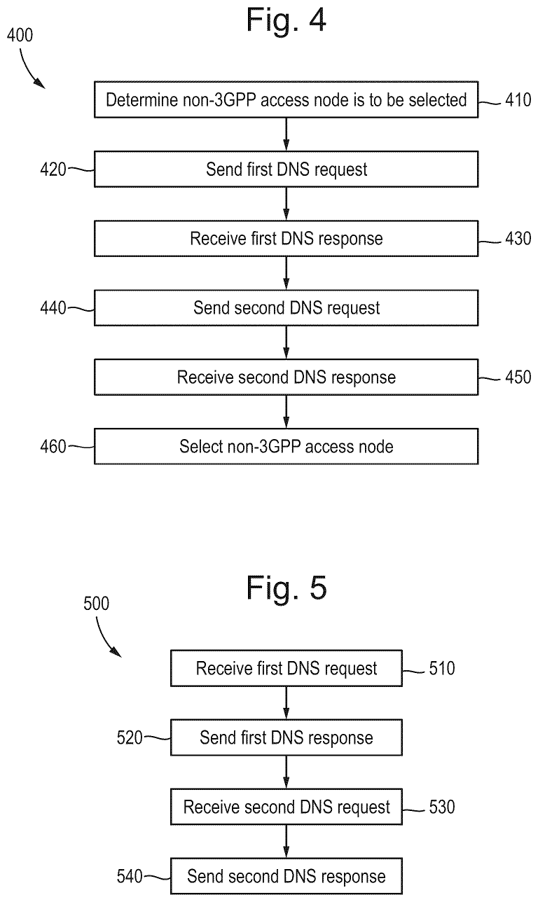

FIG. 4 illustrates a method 400 in a user apparatus arranged to communicate with a non-3GPP access network. The user apparatus may be a user equipment apparatus 200, a UE 110, 610, 710 and/or 810 as described herein. The method 400 may comprise determining 410 that a non-3GPP access node is to be selected for providing a first service over the non-3GPP access network. The method 400 may further comprise sending 420 a first DNS request, via the transceiver, the first DNS request using a first visited country FQDN associated with a first type of non-3GPP access node. The method 400 may further comprise receiving 430 a first DNS response, via the transceiver, the first DNS response containing a first list of PLMN identities. The method 400 may further comprise sending 440 a second DNS request, via the transceiver, the second DNS request using a second visited country FQDN associated with a second type of non-3GPP access node. The method 400 may further comprise receiving 450 a second DNS response, via the transceiver, the second DNS response containing a second list of PLMN identities. The method 400 may further comprise selecting 460 a non-3GPP access node based upon the received first and second DNS responses.

The user apparatus may be a user equipment (UE). The non-3GPP access node may be an ePDG or an N3IWF. The first service may be an IMS service. The user apparatus may be a roaming user apparatus. The roaming user apparatus may be defined as roaming by virtue of it being unable to connect to its home network. Roaming extends the coverage of a home operator's network services by allowing a user equipment to use another operator's network, which may be in another country (international roaming) or in the same country (national roaming).

The user apparatus may be determined that a non-3GPP access node is to be selected for providing a first service over the non-3GPP access network in response to determining that an IMS service should be provided over non-3GPP access and the user apparatus is located in a visited country, and it is not already connected to a non-3GPP access node. In such a situation the user apparatus must select and connect to a non-3GPP access node for being able to provide the IMS service.

The selected non-3GPP access node can be located in a visited PLMN, or in the home PLMN. How a PLMN is selected is specified in 3GPP specs (such as TS 23.501 v17.0.0 and TS 24.502 v17.4.0). For example, the selected PLMN may be the highest priority PLMN in the N3ANSI.

How a first type or a second type of non-3GPP access node in the selected PLMN is selected, is specified already in 3GPP specs (TS 23.501 v17.0.0 and TS 24.502 v17.4.0). For example, the “preference” parameter in the N3ANSI may be used for selecting the PLMN. If the “preference” indicates N3IWF but the UE cannot connect to an N3IWF in the selected PLMN, then the UE attempts to connect to an ePDG in the selected PLMN. If the “preference” indicates ePDG but the UE cannot connect to an ePDG in the selected PLMN, then the UE attempts to connect to an N3IWF in the selected PLMN. If that fails too, the UE goes back and selects another PLMN from the candidate list of PLMNs (e.g., the second highest priority PLMN in the N3ANSI).

The user apparatus may send two DNS requests and construct a candidate list of PLMNs from the received two DNS responses. It may then select a PLMN from the candidate list of PLMNs.

The method may further comprise constructing a candidate list of PLMNs using the first list of PLMN identities and the second list of PLMN identities; selecting a PLMN from the candidate list of PLMNs; wherein selecting a non-3GPP access node based upon the received first and second DNS responses comprises select a first type or a second type of non-3GPP access node in the selected PLMN.

The candidate list of PLMNs may contain the PLMNs in the visited country which can be used for selecting the first type of non-3GPP access node and may contain the PLMNs in the visited country which can be used for selecting the second type of non-3GPP access node.

The first type of non-3GPP access node may be a N3IWF. The First visited country FQDN may comprise “n3iwf.5gc.mcc<MCC>.visited-country.pub.3gppnetwork.org”, where MCC is the Mobile Country Code of the visited country.

The first DNS response may contain the PLMN identities in the visited country that can be used for N3IWF selection. The first DNS response may indicate that no PLMNs in the visited country can be used for N3IWF selection. Such an indication may be given by a list with zero entries in the first DNS response.

The second type of non-3GPP access node may be an ePDG. The second visited country FQDN may comprise “epdg.epc.mcc<MCC>.visited-country.pub.3gppnetwork.org”, where MCC is the Mobile Country Code of the visited country. Typically, the second DNS request may be sent in response to determining that the first service is an IMS service.

FIG. 5 illustrates a method 500 performed by a non-3GPP access point arranged to communicate with a user apparatus via a non-3GPP access network. The method 500 may comprise receiving 510 a first DNS request, via the transceiver, the first DNS request using a first visited country FQDN associated with a first type of non-3GPP access node. The method 500 may further comprise sending 520 a first DNS response, via the transceiver, the first DNS response containing a first list of PLMN identities. The method 500 may further comprise receiving 530 a second DNS request, via the transceiver, the second DNS request using a second visited country FQDN associated with a second type of non-3GPP access node. The method 500 may further comprise sending 540 a second DNS response, via the transceiver, the second DNS response containing a second list of PLMN identities.

The non-3GPP access point may be a WLAN access point such as a WiFi™ access point. The non-3GPP access point may comprise an access point 120, 620 and/or a network node 300 as described herein. The user apparatus may be a user equipment apparatus 200, a UE 110, 610, 710 and/or 810 as described herein. The non-3GPP access node may be an ePDG or an N3IWF. The first service may be an IMS service.

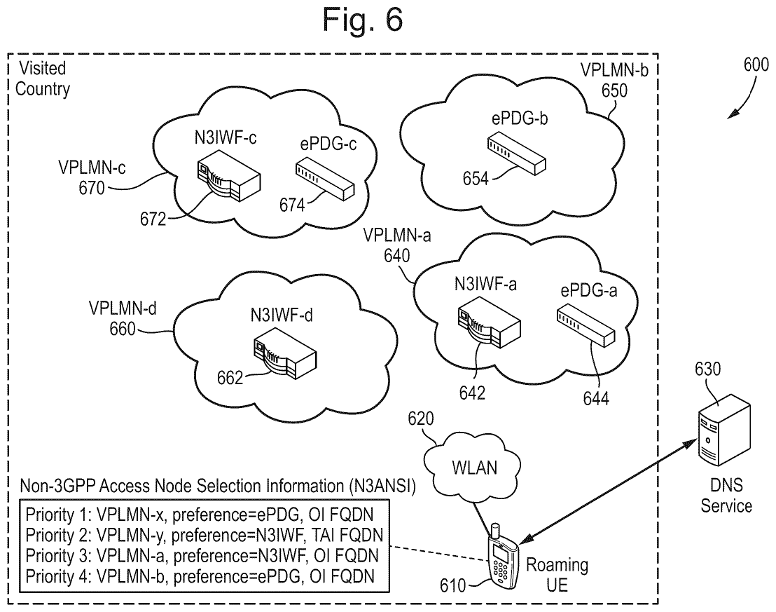

FIG. 6 illustrates a typical system 600 for implementing the methods and apparatus described herein. The system 600 comprises a roaming UE connecting to a wireless communications network in a visited country. The system 600 comprises a non-3GPP access network, in this case a WLAN 620, a DNS 630 and a plurality of Visited Public Land Mobile Networks (VPLMN). VPLMN-a 640 comprises an N3IWF-a 642 and an ePDG-a 644; VPLMN-b 650 comprises an ePDG-b 654; VPLMN-c 660 comprises an N3IWF-c 662 and an ePDG-c 664; and VPLMN-d 670 comprises an N3IWF-d 672.

Each VPLMN may contain an 5G Core (5GC) network, which includes one or multiple N3IWFs, and may contain an Enhanced Packet Core (EPC) network, which includes one or multiple ePDGs. In system 600 VPLMN-b 650 does not have a 5GC, and VPLMN-d 660 does not include an EPC.

The UE may be capable of supporting connectivity with an ePDG only, or connectivity with an N3IWF only, or connectivity with an ePDG and with an N3IWF. In the latter case, the UE may select to connect either with an ePDG or with an N3IWF. The steps of the procedure presented herein for non-3GPP access node selection (aka combined N3IWF/ePDG selection) are explained in detail below. As specified in 3GPP specifications, the UE may be configured by a Home Public Land Mobile Network (HPLMN) with “Non-3GPP access node selection information” (N3ANSI), which contains a prioritized list of PLMNs, such as:
Priority 1: VPLMN-x, Preference=ePDG, FQDN=Operator Identifier (OI) FQDN;
Priority 2: VPLMN-y, Preference=N3IWF, FQDN=Tracking Area Identity (TAI) FQDN;
Priority 3: VPLMN-a, Preference=N3IWF, FQDN=Operator Identifier (OI) FQDN; and
Priority 4: VPLMN-b, Preference=ePDG, FQDN=Operator Identifier (OI) FQDN.

The N3ANSI provides assistance information that aids the UE selecting a PLMN and an N3IWF or an ePDG in this PLMN.

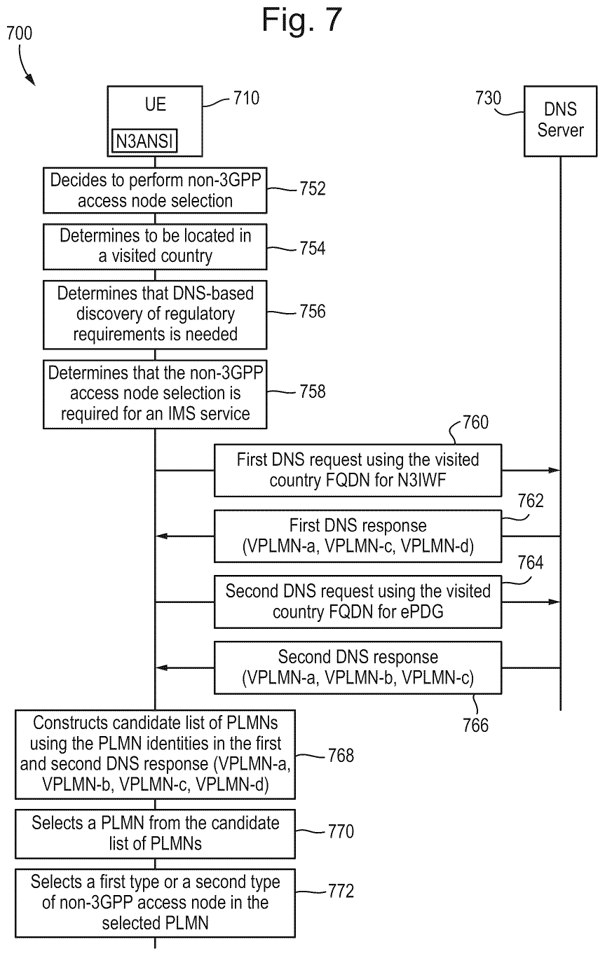

FIG. 7 illustrates a method 700 for a UE 710 communicating with a DNS server 730 and performing non-3GPP access selection for an IMS service.

At 752, the UE determines that a non-3GPP access node (either an N3IWF or an ePDG) is to be selected.

At 754, the UE attempts to determine the country it is located in. This is determined by implementation-specific methods. If the UE cannot determine the country it is located in, the UE shall stop the non-3GPP access node selection.

If the UE determines it is located in its home country, then: the UE shall select the HPLMN. If the UE fails to connect to an ePDG/N3IWF in the HPLMN, then the UE shall stop the non-3GPP access node selection.

If the UE determines it is located in a country other than its home country (called the visited country), then: if the UE is registered via 3GPP access to a PLMN and this PLMN is included in the Non-3GPP access node selection information (N3ANSI), then the UE shall select this PLMN. If the UE fails to connect to an ePDG/N3IWF in this PLMN, the UE shall select another PLMN by performing the DNS procedure beginning at step 756, described below.

When the UE is not configured with the Non-3GPP access node selection information, or the UE is registered via 3GPP access to a PLMN but this PLMN is not included in the Non-3GPP access node selection information, or the UE is not registered via 3GPP access to any PLMN, the UE shall select a PLMN by performing the DNS procedure beginning at step 756 below.

At 756, the UE determines that DNS-based discovery of regulatory requirements is needed. The UE shall also determine if the non-3GPP access node selection is required for an IMS service or for a non-IMS service. The means of that determination are implementation specific.

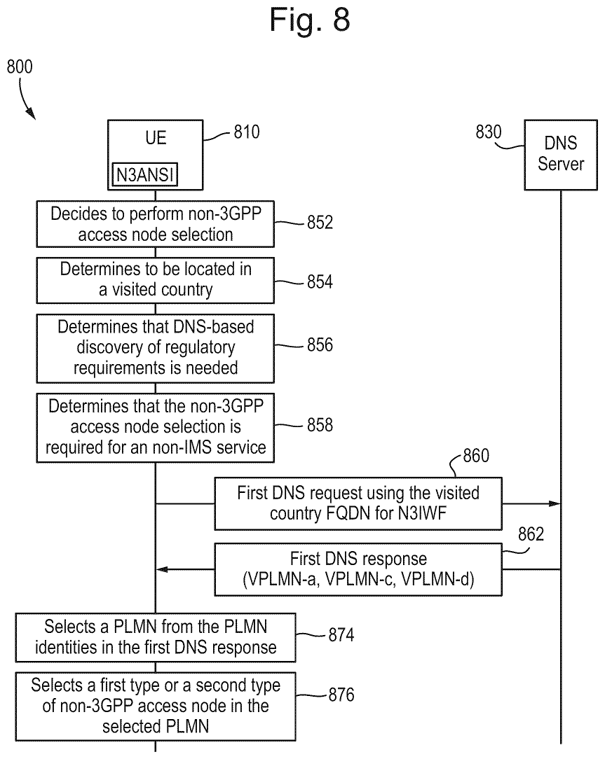

FIG. 8 illustrates the process for non-3GPP access node selection for a non-IMS service, and this is described in detail further below.

Returning to FIG. 7, at 758, if the UE determines that the non-3GPP access node selection is required for an IMS service, the UE shall select a PLMN as follows; note that the UE may select an N3IWF or an ePDG.

At 760 the UE performs a first DNS query using Visited Country FQDN for N3IWF, as specified in TS 23.003 v17.4.0 to determine if the visited country mandates the selection of N3IWF in this country. At 762, the UE 710 receives a DNS response from the DNS server 630. The DNS response may be empty or may contain the identities of one or more PLMNs in the visited country, which may be used for N3IWF selection. For example, the DNS response may contain the identity of VPLMN-a, the identity of VPLMN-c, and the identity of VPLMN-d.

At 764 the UE 710 sends a second DNS query to the DNS server 730 using Visited Country FQDN for ePDG, as specified in TS 23.003 v17.4.0 to determine if the visited country mandates the selection of ePDG in this country. At 766, the DNS response received by the UE 710 may be empty or may contain the identities of one or more PLMNs in the visited country, which may be used for ePDG selection. For example, the DNS response may contain the identity of VPLMN-a, the identity of VPLM-b, and the identity of VPLMN-c.

If the UE does not receive a DNS response in none of the above two DNS queries, then the UE shall stop the non-3GPP access node selection. Otherwise, the next steps are executed.

At 768, the UE 710 consolidates the PLMN identities received in the above two DNS responses and constructs a candidate list of PLMNs. For example, the candidate list of PLMNs may contain the identities of VPLMN-a, VPLMN-b, VPLMN-c, and VPLMN-d.

However, if the candidate list of PLMNs is empty, then if the Non-3GPP access node selection information contains one or more PLMNs in the visited country, the UE shall select one of these PLMNs based on their priorities in the Non-3GPP access node selection information. If the UE fails to connect to a non-3GPP access node in any of these PLMNs, the UE shall select the HPLMN. Otherwise, the UE shall select the HPLMN.

If the candidate list of PLMNs is not empty, then at 770, the UE 710 selects a PLMN from the candidate list of PLMNs. The selection is performed as follows.

If the UE is registered via 3GPP access to a PLMN which is included in the candidate list of PLMNs, then the UE shall select this PLMN. If the UE fails to connect to a non-3GPP access node in this PLMN, then the UE shall select a different PLMN included in the candidate list of PLMNs as specified in the next bullet.

If the UE is registered via 3GPP access to a PLMN which is not included in the candidate list of PLMNs, or the UE is not registered via 3GPP access to any PLMN, or the UE fails to connect to a non-3GPP access node according to previous bullet, then the UE shall select one of the PLMNs included in the candidate list of PLMNs based on the prioritized list of PLMNs in the Non-3GPP access node selection information (i.e. the UE shall select first the highest priority PLMN in the Non-3GPP access node selection information that is contained in the candidate list of PLMNs). If the Non-3GPP access node selection information does not contain any of the PLMNs in the candidate list of PLMNs, or the UE is not configured with the Non-3GPP access node selection information, or the UE was not able to connect to a non-3GPP access node in any of the PLMNs included in the Non-3GPP access node selection information and in the candidate list of PLMN, then the UE shall select a PLMN included in the candidate list of PLMNs based on its own implementation means.

If the UE cannot select a non-3GPP access node in any of the PLMNs included in the candidate list of PLMNs, then the UE shall stop the non-3GPP access node selection.

At 772, in the selected PLMN the UE shall attempt to select a non-3GPP access node as follows.

The UE shall determine if the non-3GPP access node selection is required for an IMS service or for a non-IMS service. The means of that determination are implementation-specific.

When the selection is required for an IMS service, the UE shall choose a non-3GPP access node type (i.e. ePDG or N3IWF) based on the “Preference” parameter specified in TS 23.501 v17.3.0, clause 6.3.6.1, unless the UE has its 5GS capability disabled in which case it shall choose an ePDG independent of the “Preference” parameter setting. If the “Preference” parameter for the selected PLMN indicates that ePDG is preferred, the UE shall attempt to select an ePDG. If the “Preference” parameter for the selected PLMN indicates that N3IWF is preferred, the UE shall attempt to select an N3IWF. If the selection fails, including the case when, during the registration performed over either 3GPP or non-3GPP access, the UE receives the IMS Voice over PS session Not Supported over Non-3GPP Access indication (specified in TS 23.501 v17.3.0, clause 5.16.3.2a), the UE shall attempt selecting the other non-3GPP access node type in the selected PLMN, if any. If that selection fails too, or it is not possible, then the UE shall select another PLMN, according to the procedure specified at 770 and described above.

For completeness, FIG. 8 illustrates a method 800 of a UE 810 communicating with a DNS server 830 and performing non-3GPP access selection for a non-IMS service. Steps 852, 854 and 856 proceed as steps 752, 754 and 756 described above.

If at 858 the UE determines that the non-3GPP access node selection is required for a non-IMS service, the UE shall select a PLMN as defined in the “Stand-alone N3IWF selection”. Note that, in this case, the UE may select an N3IWF only. As already specified in TS 23.501 v17.3.0, clause 6.3.6.3, as an ePDG should not be selected for a non-IMS service.

At 860, the UE performs a DNS query using Visited Country FQDN for N3IWF (i.e., “n3iwf.5gc.mcc<MCC>.visited-country.pub.3gppnetwork.org”, see TS 23.003) to determine if the visited country mandates the selection of N3IWF in this country. The DNS query is sent to DNS server 830. At 862 a DNS response is received from the DNS server 830 by the UE 810. The DNS response may be empty or may contain the identities of one or more PLMNs in the visited country, which may be used for N3IWF selection. For example, the DNS response may contain the identity of VPLMN-a, the identity of VPLMN-c, and the identity of VPLMN-d.

If the DNS response is empty, then: if the Non-3GPP access node selection information contains one or more PLMNs in the visited country, the UE shall select one of these PLMNs based on their priorities in the Non-3GPP access node selection information. If the UE fails to connect to a non-3GPP access node in any of these PLMNs, the UE shall select the HPLMN. Otherwise, the UE shall select the HPLMN.

If the DNS response is not empty, then at 874, the UE 810 selects a PLMN from the candidate list of PLMNs. The selection is performed as follows.

If the UE is registered via 3GPP access to a PLMN which is included in the DNS response, then the UE shall select this PLMN. If the UE fails to connect to a non-3GPP access node in this PLMN, then the UE shall select a different PLMN included in the DNS response. However, if the UE is registered via 3GPP access to a PLMN which is not included in the DNS response, or the UE is not registered via 3GPP access to any PLMN, or the UE fails to connect to a non-3GPP access node then the UE shall select one of the PLMNs included in the DNS response based on the prioritized list of PLMNs in the Non-3GPP access node selection information (i.e. the UE shall select first the highest priority PLMN in the Non-3GPP access node selection information that is contained in the DNS response). If the Non-3GPP access node selection information does not contain any of the PLMNs in the DNS response, or the UE is not configured with the Non-3GPP access node selection information, or the UE was not able to connect to a non-3GPP access node in any of the PLMNs included in the Non-3GPP access node selection information and in the DNS response, then the UE shall select a PLMN included in the DNS response based on its own implementation means. If the UE cannot select a non-3GPP access node in any of the PLMNs included in the DNS response, then the UE shall stop the non-3GPP access node selection.

In the selected PLMN the UE shall attempt to select 876 a non-3GPP access node as follows. The UE shall perform the selection by giving preference to the N3IWF independent of the “Preference” parameter setting. If the N3IWF selection fails, or it is not possible, the UE selects another PLMN based on the procedure specified in clause 4.5.4.4 of TS 23.402 v17.0.0, and attempts to select an N3IWF in this PLMN. If the UE fails to select an N3IWF in any PLMN, the UE may attempt to select an ePDG according to the procedure specified in clause 4.5.4.5 of TS 23.402 v17.0.0.

In all of the above procedures, when the UE attempts to construct a Tracking/Location Area Identifier FQDN either for ePDG selection or for N3IWF selection, the UE shall use the Tracking Area wherein the UE is located and shall construct either:
an ePDG or N3IWF TAI FQDN based on the 5GS TAI, when the UE is registered to the 5GS; or
an ePDG or N3IWF TAI FQDN based on the EPS TAI, when the UE is registered to EPS.

It should further be noted that a UE performing both a selection for an IMS service and a selection for a non-IMS service could get simultaneously attached to a N3IWF and to an ePDG in the same PLMN or in different PLMNs.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
determine that a non-3GPP access node is to be selected for providing a first service over a non-3GPP access network;
send a first domain name system (DNS) request, wherein the first DNS request uses a first visited country fully qualified domain name (FQDN) associated with a first type of non-3GPP access node;
receive a first DNS response, wherein the first DNS response contains a first list of public land mobile network (PLMN) identities;
send a second DNS request, wherein the second DNS request uses a second visited country FQDN associated with a second type of non-3GPP access node;
receive a second DNS response, wherein the second DNS response contains a second list of PLMN identities; and
select a non-3GPP access node based upon the received first and second DNS responses.

2. The UE of claim 1, wherein the at least one processor is further configured to cause the UE to:
construct a candidate list of PLMNs using the first list of PLMN identities and the second list of PLMN identities; and
select a PLMN from the candidate list of PLMNs,
wherein selecting a non-3GPP access node based upon the received first and second DNS responses comprises selecting a first type or a second type of non-3GPP access node in the selected PLMN.

3. The UE of claim 1, wherein the first type of non-3GPP access node is a non-3GPP inter working function (N3IWF).

4. The UE of claim 1, wherein the first DNS response contains the PLMNs in the visited country that can be used for non-3GPP inter working function (N31WF) selection.

5. The UE of claim 1, wherein the second type of non-3GPP access node is an evolved packet data gateway (ePDG).

6. The UE of claim 1, wherein the second DNS response contains the PLMNs in the visited country which can be used for evolved packet data gateway (ePDG) selection.

7. The UE of claim 1, wherein the first service is an IP-Multimedia System (IMS) service, and wherein the UE sends the first DNS request and the second DNS request in response to determining that the non-3GPP access node selection is required for providing an IMS service; and wherein the UE sends only the first DNS request in response to determining that the non-3GPP access node selection is required for providing a non-IMS service.

8. A method performed by a user equipment (UE), the method comprising:
determining that a non-3GPP access node is to be selected for providing a first service over anon-3GPP access network;
sending a first domain name system (DNS) request, wherein the first DNS request uses a first visited country fully qualified domain name (FQDN) associated with a first type of non-3GPP access node;
receiving a first DNS response, wherein the first DNS response contains a first list of public land mobile network (PLMN) identities;
sending a second DNS request, wherein the second DNS request uses a second visited country FQDN associated with a second type of non-3GPP access node;
receiving a second DNS response, wherein the second DNS response contains a second list of PLMN identities; and
selecting a non-3GPP access node based upon the received first and second DNS responses.

9. The method of claim 8, further comprising:
constructing a candidate list of PLMNs using the first list of PLMN identities and the second list of PLMN identities; and
selecting a PLMN from the candidate list of PLMNs,
wherein selecting a non-3GPP access node based upon the received first and second DNS responses comprises select a first type or a second type of non-3GPP access node in the selected PLMN.

10. The method of claim 8, wherein the first type of non-3GPP access node is a non-3GPP inter working function (N3IWF).

11. The method of claim 8, wherein the first DNS response contains the PLMNs in the visited country that can be used for non-3GPP inter working function (N31WF) selection.

12. The method of claim 8, wherein the second type of non-3GPP access node is an evolved packet data gateway (ePDG).

13. A non-3GPP access point for wireless communication, comprising:
at least one memory; and
at least one processor coupled with at least one memory and configured to cause the non-3GPP access point to:
receive, from a user equipment via a non-3GPP access network, a first domain name system (DNS) request, wherein the first DNS request uses a first visited country fully qualified domain name (FQDN) associated with a first type of non-3GPP access node;
send a first DNS response, wherein the first DNS response contains a first list of public land mobile network (PLMN) identities;
receive a second DNS request, wherein the second DNS request uses a second visited country FQDN associated with a second type of non-3GPP access node; and
send a second DNS response, wherein the second DNS response contains a second list of PLMN identities.

14. The non-3GPP access point of claim 13, wherein the at least one processor is further configured to cause the non-3GPP access point to receive from the UE an indication of a selection of a non-3GPP access node based upon the first and second DNS responses sent to the user apparatus.

15. (canceled)

16. A processor for wireless communication, comprising:
at least one controller coupled with at least one memory and configured to cause the processor to:
determine that a non-3GPP access node is to be selected for providing a first service over a non-3GPP access network;
send a first domain name system (DNS) request, wherein the first DNS request uses a first visited country fully qualified domain name (FQDN) associated with a first type of non-3GPP access node;
receive a first DNS response, wherein the first DNS response contains a first list of public land mobile network (PLMN) identities;
send a second DNS request, wherein the second DNS request uses a second visited country FQDN associated with a second type of non-3GPP access node;
receive a second DNS response, wherein the second DNS response contains a second list of PLMN identities; and
select a non-3GPP access node based upon the received first and second DNS responses.

17. The processor of claim 16, wherein the at least one controller is further configured to cause the processor to:
construct a candidate list of PLMNs using the first list of PLMN identities and the second list of PLMN identities; and
select a PLMN from the candidate list of PLMNs,
wherein selecting a non-3GPP access node based upon the received first and second DNS responses comprises selecting a first type or a second type of non-3GPP access node in the selected PLMN.

18. The processor of claim 16, wherein the first type of non-3GPP access node is a non-3GPP inter working function (N3IWF).

19. The processor of claim 16, wherein the first DNS response contains the PLMNs in the visited country that can be used for non-3GPP inter working function (N3IWF) selection.
